(19) United States
(12) Patent Application Publication
(10) Pub. No.: US 2022/0060913 A1
(43) Pub. Date: Feb. 24, 2022

(54) METHOD FOR CONFIGURING RESOURCE POOL, TERMINAL AND NETWORK DEVICE

(71) Applicant: GUANGDONG OPPO MOBILE TELECOMMUNICATIONS CORP., LTD., Dongguan (CN)

(72) Inventors: Zhenshan Zhao, Dongguan (CN); Qianxi Lu, Dongguan (CN); Huei-Ming Lin, Victoria (AU)

(73) Assignee: GUANGDONG OPPO MOBILE TELECOMMUNICATIONS CORP., LTD., Dongguan (CN)

(21) Appl. No.: 17/521,228

(22) Filed: Nov. 8, 2021

Related U.S. Application Data
(63) Continuation of application No. PCT/CN2019/086484, filed on May 10, 2019.

(51) Int. Cl. H04W 24/02; H04W 8/24; H04W 72/04

(52) U.S. Cl. CPC H04W 24/02; H04W 72/048; H04W 8/245

(57) ABSTRACT

Embodiments of the present application disclose a method for configuring a resource pool, a terminal, and a network device. The method includes: configuring, by a network device, at least one resource pool for sidelink data transmission for the first terminal, where the at least one resource pool is located in a bandwidth part (BWP) of the first terminal; sending, by the network device, configuration information for indicating a configuration of the at least one resource pool to the first terminal.

### CROSS-REFERENCE TO RELATED APPLICATION

This application is a continuation of International Application No. PCT/CN2019/086484, filed on May 10, 2019, which is hereby incorporated by reference in its entirety.

### TECHNICAL FIELD

The present application relates to the field of Internet of Vehicles communication technology and, in particular to a method for configuring a resource pool, a terminal, and a network device.

### BACKGROUND

Device to device communication is a sidelink (SL) transmission technology based on device to device (D2D), which is different from the way of communication data being received or sent through a base station in a traditional cellular system. An Internet of Vehicles system uses terminal-to-terminal direct communication, and thus has higher spectrum efficiency and lower transmission delay.

In new radio-vehicle to everything (NR-V2X), higher requirements are put forward for data interaction between vehicles, such as higher throughput, lower delay, higher reliability, larger coverage, more flexible resource allocation, etc. An NR-V2X system can work in large-bandwidth scenarios. For example, a bandwidth of one carrier may be 400 MHz. However, due to cost or power limitations, some terminals can hardly support large-bandwidth data transmission or reception. Therefore, a bandwidth part (BWP) is introduced in NR-V2X.

But a terminal only supports one BWP on one carrier. Therefore, in the case that bandwidths supported by terminals are unequal in size, there is currently no effective solution of how to flexibly and effectively use the bandwidths that the terminals can support for sidelink data transmission.

### SUMMARY

Embodiments of the present application provide a method for configuring a resource pool, a terminal, and a network device.

In a first aspect, an embodiment of the present application provides a method for configuring a resource pool. The method includes: configuring, by a network device, at least one resource pool for sidelink data transmission for a first terminal, where the at least one resource pool is located in a BWP of the first terminal; sending, by the network device, configuration information for indicating a configuration of the at least one resource pool to the first terminal.

In a second aspect, an embodiment of the present application provides a method for configuring a resource pool. The method includes: obtaining, by a first terminal, configuration information for indicating a configuration of at least one resource pool sent by a network device, where the at least one resource pool is located in a BWP of the first terminal; performing, by the first terminal, sidelink data transmission according to the configuration information.

In a third aspect, an embodiment of the present application provides a network device. The network device includes a configuration unit and a first communication unit; where the configuration unit is configured to configure at least one resource pool for sidelink data transmission for a first terminal, where the at least one resource pool is located in a BWP of the first terminal; and the first communication unit is configured to send configuration information for indicating a configuration of the at least one resource pool to the first terminal.

In a fourth aspect, an embodiment of the present application provides a terminal. The terminal is a first terminal, and the terminal includes a second communication unit and a selection unit; where the second communication unit is configured to obtain configuration information for indicating a configuration of at least one resource pool sent by a network device, where the at least one resource pool is located in a BWP of the first terminal; and the selection unit is configured to perform sidelink data transmission according to the configuration information.

In a fifth aspect, an embodiment of the present application provides a network device, including a processor and a memory, where the memory is configured to store a computer program, and the processor is configured to call and run the computer program stored in the memory to execute the method for configuring a resource pool described in the above embodiments of the present application.

In a sixth aspect, an embodiment of the present application provides a terminal, including a processor and a memory. The memory is configured to store a computer program, and the processor is configured to call and run the computer program stored in the memory to execute the method for configuring a resource pool described above.

In a seventh aspect, an embodiment of the present application provides a chip, including: a processor, configured to call and run a computer program from a memory, to cause a device installed with the chip to execute the method for configuring a resource pool of the above first aspect or second aspect.

In an eighth aspect, an embodiment of the present application provides a computer-readable storage medium for storing a computer program which causes a computer to execute the method for configuring a resource pool of the above first aspect or second aspect.

In a ninth aspect, an embodiment of the present application provides a computer program product including computer program instructions which cause a computer to execute the method for configuring a resource pool of the above first aspect or second aspect.

In a tenth aspect, an embodiment of the present application provides a computer program which, when running on a computer, causes a computer to execute the method for configuring a resource pool of the above first aspect or second aspect.

Using the above technical solutions of the embodiments of the present application, at least one resource pool for sidelink data transmission is configured for the terminal through the network device, and the at least one resource pool is located in the BWP of the first terminal, so that the terminal can perform sidelink data transmission according to the configuration information for indicating the configuration of the at least one resource pool. In this way, when the terminal communicates with a terminal with a different capability, a corresponding resource pool can be used for sidelink data transmission, which improves bandwidth utilization.

### BRIEF DESCRIPTION OF DRAWINGS

The drawings described here are used to provide a further understanding of the present application and constitute a part of the present application. The exemplary embodiments of the present application and descriptions thereof are used to explain the present application, and do not constitute an improper limitation on the present application. In the attached drawings:

FIG. 1a and FIG. 1b are both schematic diagrams of a communication system architecture according to an embodiment of the present application;

FIG. 2 is a schematic flowchart of a method for configuring a resource pool according to an embodiment of the present application;

FIG. 3 is a schematic diagram of an application scenario of a method for configuring a resource pool according to an embodiment of the present application;

FIG. 4a to FIG. 4e each are a schematic diagram of a configuration of a resource pool in a method for configuring a resource pool according to an embodiment of the present application;

FIG. 5 is a schematic diagram of a structural composition of a network device according to an embodiment of the present application;

FIG. 6 is a schematic diagram of a structural composition of a terminal according to an embodiment of the present application;

FIG. 7 is a schematic structural diagram of a communication device according to an embodiment of the present application; and

FIG. 8 is a schematic structural diagram of a chip according to an embodiment of the present application.

### DESCRIPTION OF EMBODIMENTS

The technical solutions in embodiments of the present application will be described below in conjunction with the drawings in the embodiments of the present application. Obviously, the described embodiments are part of the embodiments of the present application, not all of the embodiments. All other embodiments obtained based on the embodiments of the present application by those of ordinary skill in the art without creative effort are within the protection scope of the present application.

The technical solutions of the embodiments of the present application can be applied to an Internet of Vehicles system. The Internet of Vehicles is a huge interactive network consisting of information such as vehicle location, speed, and route. Vehicles can complete collection of their own environment and state information through a global positioning system (GPS), radio frequency identification (RFID), sensors, camera image processing and other apparatuses; all vehicles can transmit and converge their own various information to a central processing unit through Internet technology; these large amount of vehicle information can be analyzed and processed through computer technology to calculate best routes for different vehicles, report road conditions in time, arrange signal light period, etc.

Data transmission in the Internet of Vehicles system can be based on a mobile communication network, such as: a global system of mobile communication (GSM) system, a code division multiple access (CDMA) system, a wideband code division multiple access (WCDMA) system, a general packet radio service (GPRS) system, a long term evolution (LTE) system, an LTE frequency division duplex (FDD) system, an LTE time division duplex (TDD) system, a universal mobile telecommunication system (UMTS), a worldwide interoperability for microwave access (WiMAX) communication system or a 5G system, etc.

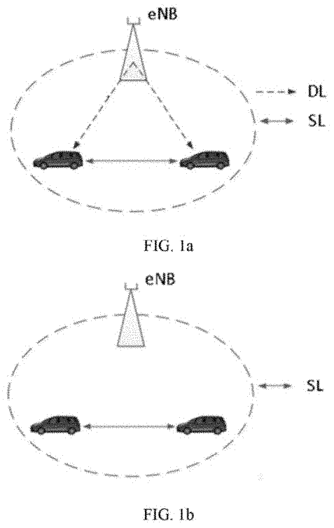

Exemplarily, an Internet of Vehicles system to which the embodiments of the present application are applied is shown in FIG. 1a and FIG. 1b. The Internet of Vehicles system may include a network device and a terminal, and the network device may be a device that communicates with the terminal (or called a communication terminal). The network device can provide communication coverage for a specific geographic area, and can communicate with terminals located in a coverage area. In an embodiment, the network device may be a base station (Base Transceiver Station, BTS) in a GSM system or a CDMA system, a base station (NodeB, NB) in a WCDMA system, and may also be an evolved base station (Evolutional Node B, eNB or eNodeB) in an LTE system, or a base station device gNB in a 5G system, or a wireless controller in a cloud radio access network (CRAN), etc.

The terminal in the embodiments of the present application is a vehicle terminal mounted in a vehicle.

Exemplarily, a data transmission mode in the Internet of Vehicles system in the embodiments of the present application may include two types, as shown in FIG. 1a and FIG. 1b respectively. Referring to FIG. 1a, a transmission resource of the terminal is allocated by the network device (such as an eNB shown in FIG. 1a) through a downlink (DL); and the terminal performs data transmission on a sidelink (SL) according to the transmission resource allocated by the network device. As shown in FIG. 1b, the terminal autonomously selects a transmission resource in a resource pool. Specifically, the terminal can obtain the transmission resource by means of listening, or randomly select the transmission resource from the resource pool. The terminal performs data transmission through the SL based on the selected transmission resource.

In an embodiment, the 5G system or the 5G network may also be referred to as a new radio (NR) system or an NR network.

FIG. 1a and FIG. 1b exemplarily show one network device and two terminals. In an embodiment, the Internet of Vehicles system may include multiple network devices, and other numbers of terminals may be included within a coverage of each network device, which is not limited in the embodiments of the present application.

In an embodiment, the Internet of Vehicles system may also include other network entities such as a network controller and a mobility management entity, which are not limited in the embodiments of the present application.

It should be understood that a device with a communication function in the Internet of Vehicles system in the embodiments of the present application may be referred to as a communication device. Taking the Internet of Vehicles system shown in FIG. 1a and FIG. 1b as an example, the communication device may include a network device and a terminal with communication functions. The network device and the terminal may be the above-mentioned specific devices, which will not be repeated here; the communication device may also include other devices in the Internet of Vehicles system, such as a network controller, a mobility management entity, and other network entities, which are not limited in the embodiments of the present application.

It should be understood that the terms “system” and “network” herein are often used interchangeably in the present application. The term “and/or” herein is only an association relationship that describes associated objects, which means that there can be three relationships. For example, “A and/or B” can represent three cases including that: A exists alone, A and B exist at the same time, B exists alone. In addition, the character “/” herein generally represents that associated objects before and after the character are in an “or” relationship.

The technical solutions of the embodiments of the present application are mainly applied to a 5G mobile communication system. Of course, the technical solutions of the embodiments of the present application are not limited to the 5G mobile communication system, and may also be applied to other types of mobile communication systems.

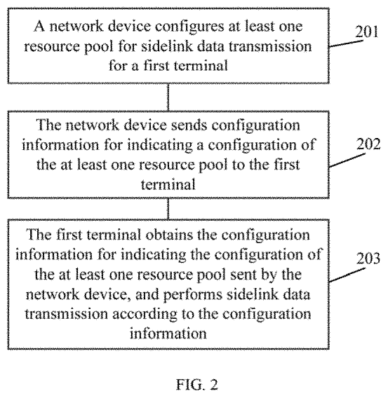

An embodiment of the present application provides a method for configuring a resource pool. FIG. 2 is a schematic flowchart of a method for configuring a resource pool according to an embodiment of the present application; as shown in FIG. 2, the method includes:

step 201: a network device configures at least one resource pool for sidelink data transmission for a first terminal; where the at least one resource pool is located in a BWP of the first terminal;

step 202: the network device sends configuration information for indicating a configuration of the at least one resource pool to the first terminal;

step 203: the first terminal obtains the configuration information for indicating the configuration of the at least one resource pool sent by the network device, and performs sidelink data transmission according to the configuration information.

In this embodiment, the network device may specifically be an access network device, which can provide communication coverage for a specific geographic area. As an example, the network device may be a base station in various communication systems, such as a base station (gNB) in a 5G system. The first terminal is any terminal within the communication coverage of the network device. It can be understood that there are multiple terminals within the communication range of the network device.

In this embodiment, the resource pool is a set of transmission resources located on a carrier, and the set of transmission resources includes frequency domain resources and time domain resources. Since the BWP is introduced in NR-V2X, and only one BWP is supported on one carrier for one terminal, based on this, the at least one resource pool configured by the network device for the terminal in this embodiment is located in the BWP of the first terminal, and different resource pools correspond to the same or different bandwidths. The BWP is a BWP configured by the network device for the first terminal, or the BWP is a predefined (or preconfigured) BWP.

In this embodiment, the at least one resource pool is used for sidelink data transmission between the first terminal and a second terminal. The second terminal may also be a terminal within the communication range of the network device.

In this embodiment, in one implementation, the network device may send the configuration information for indicating the configuration of the at least one resource pool once, that is, the configuration of the at least one resource pool is within one piece of configuration information, and the network device sends the configuration information to the first terminal. In other implementations, the network device may respectively send configuration information for indicating configurations of respective resource pools in the configuration of the at least one resource pool, that is, the configuration of the at least one resource pool is within corresponding configuration information, and each piece of configuration information includes a configuration of one resource pool.

In this embodiment, as an optional implementation, the configuration information is used for indicating a configuration of a first resource pool in the at least one resource pool. The configuration of the first resource pool includes destination address information, and the destination address information is used for determining the second terminal with which the first terminal performs sidelink data transmission based on the first resource pool. The destination address information includes at least one of the following types of information: terminal identification, group identification, service type identification, and proximity service identification.

As a first example, if the destination address information in the configuration of the first resource pool is identification of a terminal 1 (for example, an ID of the terminal 1), it represents that the first resource pool is used for performing sidelink data transmission with the terminal 1.

As a second example, if the destination address information in the configuration of the first resource pool is group identification, it represents that the first resource pool is used for performing sidelink data transmission with terminals within a communication group corresponding to the group identification. It can be understood that a division of communication groups may be performed for multiple terminals in advance, and group identification may be configured for each communication group. The corresponding communication group can be determined through the group identification, and the terminals within the communication group can also be determined.

As a third example, if the destination address information in the configuration of the first resource pool is service type identification, it represents that the first resource pool is used for sidelink data transmission of a service corresponding to the service type identification. For example, a service type corresponding to the service type identification may be a cooperative awareness message (CAM), which represents that the first resource pool can be used for CAM-type sidelink data transmission. Of course, the service type in this embodiment is not limited to that shown above, and other service types are also within the protection scope of this embodiment, and will not be repeated here.

As a fourth example, if the destination address information in the configuration of the first resource pool is proximity service identification, it represents that the first resource pool is used for sidelink data transmission of a service corresponding to the proximity service identification.

As an example, the destination address information may indicate a broadcast transmission mode, which represents that the resource pool is used for sidelink broadcast transmission. For example, if the destination address information includes the terminal identification and/or the group identification, it can be determined that the corresponding resource pool is used for sidelink data transmission in a unicast or multicast mode. Identification with a specific meaning may also be used in the destination address information to indicate the broadcast transmission mode, and a resource pool corresponding to the identification is used for sidelink data transmission in a broadcast mode.

In an optional embodiment of the present application, the configuration of the first resource pool includes at least one of the following: at least one piece of destination address information belonging to a same category, and at least two pieces of destination address information belonging to different categories.

In this embodiment, as an example, the destination address information included in the configuration of the first resource pool may be at least one piece of destination address information belonging to the same category. For example, the destination address information included in the configuration of the first resource pool is the identification of the terminal 1 and identification of a terminal 2, which represents that the first resource pool is used for performing sidelink data transmission with the terminal 1 and the terminal 2.

As another example, the destination address information included in the configuration of the first resource pool may be at least two pieces of destination address information belonging to different categories. For example, the destination address information included in the configuration of the first resource pool is identification and group identification of a terminal 3, which represents that the first resource pool can be used for performing sidelink data transmission with the terminal 3, and can also be used for performing sidelink data transmission with terminals in a group corresponding to the group identification.

As yet another example, the destination address information included in the configuration of the first resource pool may include at least one piece of destination address information belonging to the same category and at least two pieces of destination address information belonging to different categories. For example, the destination address information included in the configuration of the first resource pool is identification of a terminal 4, identification of a terminal 5, and service type identification, which represents that the first resource pool can be used for performing sidelink data transmission with the terminal 4 and the terminal 5, and can also be used for performing sidelink data transmission of a service corresponding to the service type identification.

In an optional embodiment of the present application, the at least one resource pool includes at least one second resource pool, where the at least one second resource pool is used for performing sidelink data transmission with a terminal with the lowest bandwidth capability; or, the at least one second resource pool is used for the first terminal to perform sidelink broadcast transmission.

In this embodiment, according to different capabilities of terminals, bandwidths that the terminals can support are also different. For example, a division into different maximum bandwidths can be performed for different capability levels. As shown in Table 1 below, 10 MHz may be used as the lowest bandwidth. That is, if a terminal only supports a bandwidth of 10 MHz, the terminal can be used as a second terminal with the lowest bandwidth capability. It can be understood that Table 1 is only a division manner for capability level identification corresponding to terminal capabilities and corresponding supported maximum bandwidths, where the higher the capability level identification, the lower the bandwidth capability that can be supported. Other division manners can also be within the protection scope of this embodiment, that is, the maximum bandwidth corresponding to the lowest bandwidth capability is not limited to the 10 MHz in Table 1.

TABLE 1

| Capability level identification | Supported maximum bandwidth |
|---|---|
| 0 | 400 MHz |
| 1 | 100 MHz |
| 2 | 20 MHz |
| 3 | 10 MHz |

As an implementation, the at least one resource pool configured by the network device for the first terminal includes at least one second resource pool, so that the first terminal can perform sidelink data transmission with a terminal with the lowest bandwidth capability based on the at least one second resource pool. This implementation is suitable for communication between terminals through a unicast or multicast mode, that is, the first terminal can determine the second terminal for sidelink data transmission, then the network device configures the at least one second resource pool for the first terminal, so that the first terminal can perform sidelink data transmission with the terminal with the lowest bandwidth capability based on the at least one second resource pool.

As another implementation, the at least one second resource pool configured by the network device for the first terminal is used for the first terminal to perform sidelink broadcast transmission; the at least one second resource pool is located within a bandwidth range of a terminal with the lowest bandwidth capability. This embodiment is applicable to a scenario where the first terminal performs broadcast communication. In this scenario, since an object of sidelink data transmission is any terminal, and the capability of each terminal may be different, based on this, the network device configures, for the first terminal, at least one second resource pool corresponding to a terminal/terminals supporting the lowest bandwidth capability, so that the first terminal can perform broadcast communication based on the at least one second resource pool, and any terminal can receive broadcast data.

In this embodiment, as an implementation, a configuration of the at least one second resource pool indicated by the configuration information does not include destination address information. This implementation shows that the at least one second resource pool is not restricted by any conditions, that is, the at least one second resource pool can be used for sidelink data transmission corresponding to any terminal and any service. Generally, the at least one second resource pool is located within the bandwidth range of the terminal with the lowest bandwidth capability, so that all terminals can support the maximum bandwidth supported by the terminal with the lowest bandwidth capability, and thus sidelink data sent by the first terminal based on the at least one second resource pool can be received by other terminals.

The method for configuring a resource pool in the embodiments of the present application will be described in detail below with reference to specific examples.

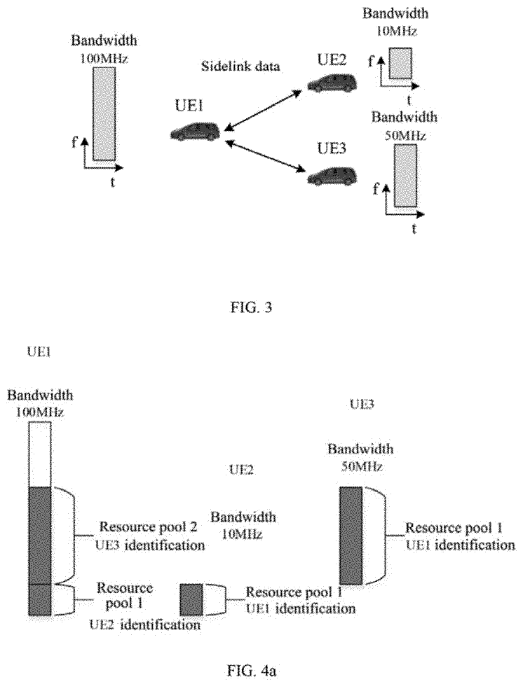

FIG. 3 is a schematic diagram of an application scenario of a method for configuring a resource pool according to an embodiment of the present application. For the application scenario of the embodiments of the present application, an application scenario shown in FIG. 3 can be referred to. As shown in FIG. 3, UE1 can perform sidelink data transmission with UE2 and UE3. The maximum bandwidth supported by UE1 is 100 MHz, the maximum bandwidth supported by UE2 is 10 MHz, and the maximum bandwidth supported by UE3 is 50 MHz. UE1 communicates with UE2, and in order to ensure that UE2 can conduct sending or receiving, UE1 can only perform sidelink data transmission within a bandwidth of 10 MHz; if UE1 communicates with UE3, then a bandwidth of 50 MHz can be used for sidelink data transmission. The technical solutions of the embodiments of the present application are used to solve the problem of how a terminal flexibly selects resources to perform sidelink data transmission with terminals with different capabilities.

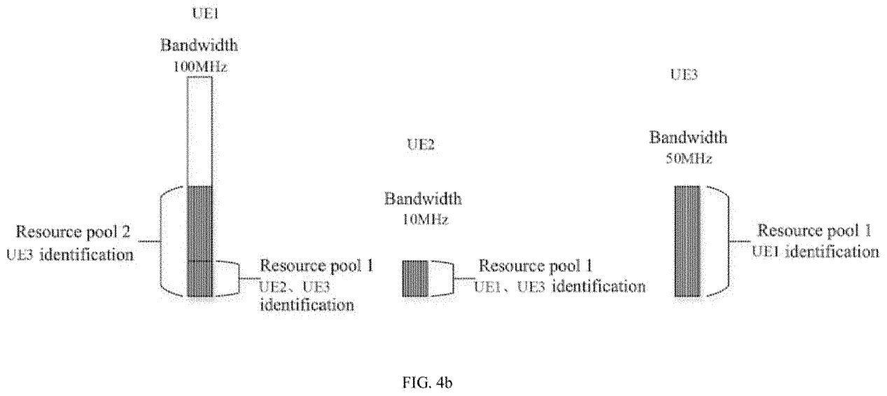

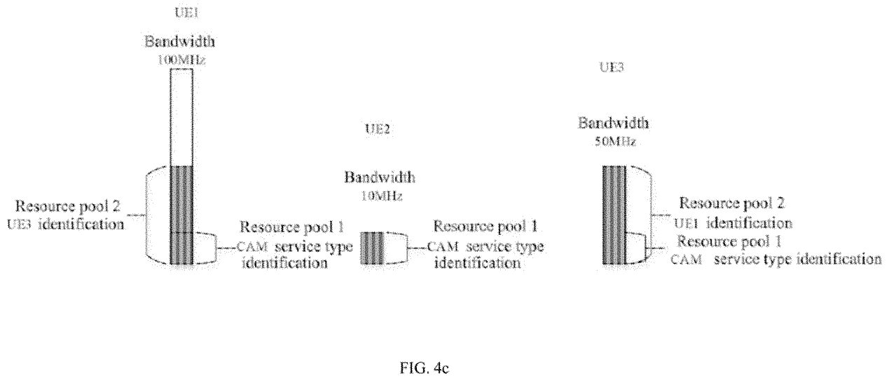

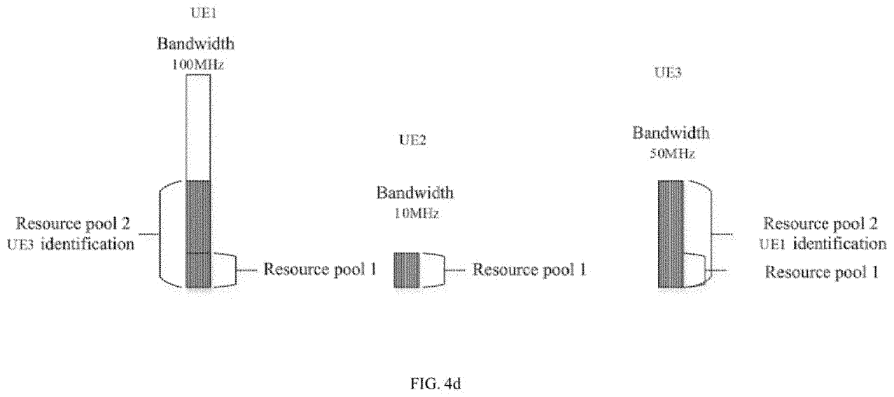

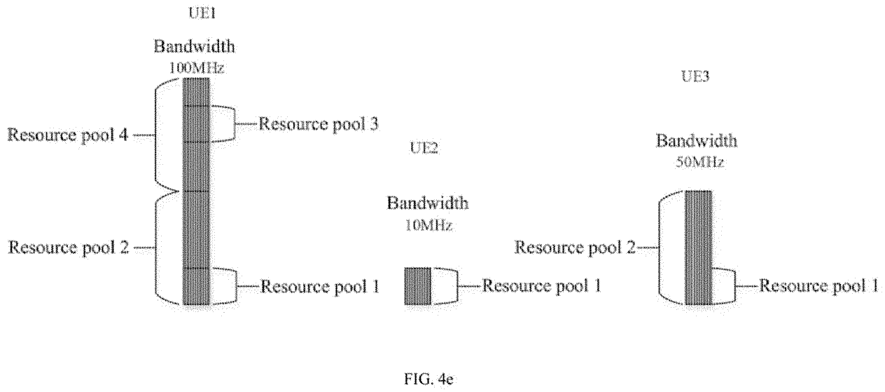

FIG. 4a to FIG. 4e each are a schematic diagram of a configuration of a resource pool in a method for configuring a resource pool according to an embodiment of the present application. In the application scenario shown in FIG. 3, manners for configuring a resource pool in embodiments of the present application will be described in detail below with reference to specific examples and FIG. 4a to FIG. 4e. In this example, the maximum bandwidth supported by UE1 is 100 MHz, the maximum bandwidth supported by UE2 is 10 Hz, and the maximum bandwidth supported by UE3 is 50 MHz.

### EXAMPLE 1

As shown in FIG. 4a, UE1 performs sidelink data transmission with UE2 and UE3. The network device can configure a resource pool 1 and a resource pool 2 for UE1. The resource pool 1 is located within a bandwidth of 10 MHz, the resource pool 2 is located within a bandwidth of 10 MHz-60 MHz, and a total bandwidth of the resource pool 2 is less than or equal to 50 MHz; configuration information of the resource pool 1 includes identification of UE2, and configuration information of the resource pool 2 includes identification of UE3. Correspondingly, the network device configures resource pools 1 for UE2 and UE3 respectively, where the resource pool 1 of UE2 is located within the bandwidth of 10 MHz, the resource pool 1 of UE3 is located within the bandwidth of 10 MHz-60 MHz, and configuration information of the resource pools 1 of UE2 and UE3 both include identification of UE1. Then UE1 can perform sidelink data transmission with UE2 using the resource pool 1, and can perform sidelink data transmission with UE3 using the resource pool 2.

### EXAMPLE 2

As shown in FIG. 4b, UE1 performs sidelink data transmission with UE2 and UE3. The network device can configure a resource pool 1 and a resource pool 2 for UE1. The resource pool 1 is located within a bandwidth of 10 MHz; the resource pool 2 is located within a bandwidth 0 MHz-50 MHz, and a total bandwidth of the resource pool 2 is less than or equal to 50 MHz; configuration information of the resource pool 1 includes identification of UE2 and identification of UE3, which represents that the resource pool 1 can be used for performing sidelink data transmission with UE2 and UE3, and configuration information of the resource pool 2 includes identification information of UE3, which represents that the resource pool 2 can only be used for performing sidelink data transmission with UE3; the bandwidth corresponding to the resource pool 2 includes the bandwidth corresponding to the resource pool 1. Correspondingly, the network device configures resource pools 1 for UE2 and UE3 respectively, where the resource pool 1 of UE2 is located within the bandwidth of 10 MHz, and the resource pool 1 of UE3 is located within the bandwidth of 0 MHz-50 MHz; configuration information corresponding to the resource pool 1 of UE2 includes identification of UE1 and the identification of UE3, which represents that the resource pool 1 is used for performing sidelink data transmission with UE1 and UE3, and configuration information corresponding to the resource pool 1 of UE3 includes the identification of UE1, which is used for indicating that the resource pool 1 is used for performing sidelink data transmission with UE1.

### EXAMPLE 3

As shown in FIG. 4c, UE1 performs sidelink transmission with UE2 and UE3. The network device can configure a resource pool 1 and a resource pool 2 for UE1. The resource pool 1 is located within a bandwidth of 10 MHz, the resource pool 2 is located within a bandwidth of 0 MHz-50 MHz, and a total bandwidth of the resource pool 2 is less than or equal to 50 MHz; configuration information of the resource pool 1 includes CAM service type identification, which represents that the resource pool 1 is used for sidelink data transmission of a service corresponding to the CAM service type identification, and configuration information of the resource pool 2 includes identification of UE3, which represents that the resource pool 2 can only be used for performing sidelink data transmission with UE3. The bandwidth corresponding to the resource pool 2 includes the bandwidth corresponding to the resource pool 1. Correspondingly, the network device configures a resource pool 1 for UE2, where the resource pool 1 of UE2 is located within the bandwidth of 10 MHz, and configuration information of the resource pool 1 includes the CAM service type identification, which represents that the resource pool 1 is used for sidelink data transmission of the service corresponding to the CAM service type identification. The network device configures a resource pool 1 and a resource pool 2 for UE3, where the resource pool 1 is located within the bandwidth of 10 MHz, the resource pool 2 is located within the bandwidth of 0 MHz-50 MHz, and a total bandwidth of the resource pool 2 is less than or equal to 50 MHz; configuration information of the resource pool 1 includes the CAM service type identification, which represents that the resource pool 1 is used for sidelink data transmission of the service corresponding to the CAM service type identification, and configuration information of the resource pool 2 includes identification of UE1, which represents that the resource pool 1 is used for performing sidelink data transmission with UE1. Based on this, UE1, UE2 and UE3 can perform CAM service transmission through resources corresponding to the resource pool 1, UE1 can perform sidelink data transmission with UE3 through resources corresponding to the resource pool 2, and UE3 can perform sidelink data transmission with UE1 through resources corresponding to the resource pool 2.

### EXAMPLE 4

As shown in FIG. 4d, UE1 performs sidelink transmission with UE2 and UE3. The network device can configure a resource pool 1 and a resource pool 2 for UE1. The resource pool 1 is located within a bandwidth of 10 MHz bandwidth, the resource pool 2 is located within a bandwidth of 0 MHz-50 MHz, and a total bandwidth of the resource pool 2 is less than or equal to 50 MHz; configuration information of the resource pool 1 does not include destination address information, and configuration information of the resource pool 2 includes identification of UE3, which represents that the resource pool 2 can only be used for performing sidelink data transmission with UE3. Correspondingly, the network device configures a resource pool 1 for UE2, where the resource pool 1 of UE2 is located within the bandwidth of 10 MHz, and configuration information of the resource pool 1 does not include the destination address information. The network device configures a resource pool 1 and a resource pool 2 for UE3, where the resource pool 1 is located within the bandwidth of 10 MHz, the resource pool 2 is located within the bandwidth of 0 MHz-50 MHz, and a total bandwidth of the resource pool 2 is less than or equal to 50 MHz; configuration information of the resource pool 1 does not include the destination address information, and configuration information of the resource pool 2 includes identification of UE1, which represents that the resource pool 1 is used for performing sidelink data transmission with UE1. The case that the configuration information of the resource pool 1 configured by the network device for UE1, UE2 and UE3 does not include the destination identification information represents that resources corresponding to the resource pool 1 can be used between UE1, UE2 and UE3 to transmit any sidelink data, and there is no restriction on a receiving terminal of the sidelink data.

In an optional embodiment of the present application, for step 202, that the network device sends the configuration information for indicating the configuration of the at least one resource pool to the first terminal includes that: the network device sends the configuration information for indicating the configuration of the at least one resource pool to the first terminal through at least one of a first broadcast message, a first radio resource control (RRC) signaling and a downlink control channel. Correspondingly, that the first terminal obtains the configuration information for indicating the configuration of the at least one resource pool sent by the network device includes that: the first terminal receives the configuration information for indicating the configuration of the at least one resource pool sent by the network device through at least one of the first broadcast message, the first RRC signaling and the downlink control channel.

Specifically, in a case that the first terminal is in an RRC idle state (RRC-IDLE state), the network device can send the configuration information for indicating the configuration of the at least one resource pool through the first broadcast message, so that the first terminal in the RRC-IDLE state can receive the first broadcast message. In a case that the first terminal is in an RRC connected state (RRC-CONNECTED state), the network device can send the configuration information for indicating the configuration of at least one resource the pool to the first terminal through the first RRC signaling or the downlink control channel. As an implementation, the downlink control channel may be downlink control information (DCI).

In an optional embodiment of the present application, the method further includes that: the first terminal sends assistance information to the network device; correspondingly, the network device receives the assistance information sent by the first terminal; where the assistance information includes at least one of the following information: first capability information of the first terminal, second capability information of a second terminal corresponding to sidelink data transmission performed by the first terminal, and identification information; the identification information includes at least one of the following information: identification information of the first terminal, identification information of the second terminal, group identification information corresponding to the first terminal, and group identification information corresponding to the second terminal.

The first capability information represents the maximum bandwidth supported by the first terminal, and the second capability information represents the maximum bandwidth supported by the second terminal. If the assistance information includes the second capability information, the assistance information may include second capability information corresponding to at least one second terminal. It can be understood that the number of an object of the sidelink data transmission of the first terminal may be at least one, which corresponds to at least one second terminal. Correspondingly, the first terminal can report at least one piece of second capability information corresponding to the at least one second terminal to the network device. Terminal identification information (the identification information of the first terminal and/or the identification information of the second terminal) in the identification information is used for determining a terminal, and the group identification information (the group identification information corresponding to the first terminal and/or the group identification information corresponding to the second terminal) in the identification information is used for determining a communication group corresponding to the sidelink transmission performed by the first terminal.

Correspondingly, that the network device configures at least one resource pool for sidelink data transmission for the first terminal includes that: the network device configures at least one resource pool for sidelink data transmission for the first terminal based on the assistance information. That the first terminal sends the assistance information to the network device includes that: the first terminal sends the assistance information to the network device through at least one of a second RRC signaling, uplink control information, a scheduling request (SR), and a buffer status report (BSR). Correspondingly, that the network device receives the assistance information sent by the first terminal includes that: the network device receives the assistance information sent by the first terminal through at least one of the second RRC signaling, the uplink control information, the SR and the BSR.

In this embodiment, the first terminal reports to the network device at least one piece of assistance information of its own first capability information, the second capability information of the second terminal, and the identification information, so that the network device configures at least one resource pool for the first terminal according to the assistance information.

As an implementation, in a scenario where the first terminal performs sidelink data transmission through broadcast communication, the receiving terminal (i.e., the second terminal) may be any terminal, and the capability of each terminal (i.e., the maximum bandwidth supported by the terminal) may be different but the lowest bandwidth capability of the terminal can be determined according to the division manner as shown in Table 1, thus the network device can configure at least one second resource pool for the terminal, so that the first terminal can perform sidelink data transmission through the at least one second resource pool when performing broadcast communication.

As another implementation, in a case that the first terminal needs to perform unicast or multicast communication, the receiving terminal (i.e., the second terminal) is usually a determined terminal. Then the network device can configure a resource pool that can be supported by capabilities of both the first terminal and the second terminal according to the assistance information sent by the first terminal, for example, according to the capabilities of the first terminal and the second terminal (i.e., maximum bandwidths supported by the terminals), to achieve the purpose of making full use of the capabilities of the terminals.

In this implementation, as an example, the first capability information and/or the second capability information are represented by capability level identification, where the capability level identification corresponds to the maximum bandwidth supported by the first terminal or the second terminal, and the capability level identification is shown in foregoing Table 1. A mapping relationship between the capability level identification and the supported maximum bandwidth may be configured by the network for the terminal or pre-stored in a terminal device.

As an implementation, the first terminal can report its own first capability information to the network device, and the network device can configure at least one resource pool for the first terminal based on the first capability information of the first terminal. The first capability information may be represented by first capability level identification. Then the network device can determine a corresponding terminal capability based on the first capability level identification, that is, determine the maximum bandwidth supported by the first terminal, and can allocate at least one resource pool for the first terminal based on the terminal capability, so that the allocated at least one resource pool is within a range of the maximum bandwidth supported by the first terminal.

In an optional embodiment of the present application, in a case that the assistance information sent by the first terminal to the network device includes the second capability information of the second terminal, before the first terminal sends the assistance information to the network device, the first terminal needs to obtain the second capability information of the second terminal, and then the method further includes that: the first terminal receives the second capability information of the second terminal corresponding to the sidelink data transmission. That the first terminal receives the second capability information of the second terminal corresponding to the sidelink data transmission includes at least one of the following: that the first terminal receives the second capability information of the second terminal corresponding to the sidelink data transmission through a first sidelink RRC signaling; that the first terminal receives a physical sidelink share channel (PSSCH) sent by the second terminal corresponding to the sidelink data transmission, the second capability information of the second terminal being carried in the PSSCH.

In an optional embodiment of the present application, for step 203, that the first terminal performs sidelink data transmission according to the configuration information includes that: the first terminal selects one or more resource pools from the at least one resource pool to perform sidelink data transmission according to the configuration information. That the first terminal selects one or more resource pools from the at least one resource pool to perform sidelink data transmission according to the configuration information, includes that: the first terminal selects one or more resource pools from the at least one resource pool to perform sidelink data transmission according to the first capability information of the first terminal and the second capability information of the second terminal corresponding to the sidelink data transmission, so that a bandwidth of the selected resource pool is within a bandwidth range corresponding to the capabilities of the first terminal and the second terminal.

As shown in FIG. 4e, the maximum bandwidth supported by UE1 is 100 MHz, and the network device configures four resource pools for UE1, where a resource pool 1 is located within a bandwidth of 10 MHz, a resource pool 2 is located within a bandwidth of 0-50 MHz, a resource pool 3 and a resource pool 4 are located within a bandwidth of 60-100 MHz bandwidth, but the bandwidth corresponding to the resource pool 4 includes the bandwidth corresponding to the resource pool 3. The maximum bandwidth supported by UE2 is 10 MHz, and the network device configures one resource pool for UE2, denoted as a resource pool 1, which is located within the bandwidth of 10 MHz. The maximum bandwidth supported by UE3 is 50 MHz, and the network device configures two resource pools for UE3, where a resource pool 1 is located within the bandwidth of 10 MHz, and a resource pool 2 is located within a bandwidth of 0-50 MHz. When UE1 and UE2 perform unicast communication, UE1 and UE2 first need to exchange their respective capability information, and will thus select a resource pool for sidelink data transmission within a bandwidth range supported by both UE1 and UE2, i.e., the resource pool 1, that is, UE1 and UE2 select the resource pool 1 to perform sidelink data transmission. When UE1 and UE3 perform sidelink data transmission, UE1 and UE3 exchange their respective capability information and learn that the maximum bandwidth that can be supported by both is 50 MHz, and will thus select a resource pool within a bandwidth range of 50 MHz to perform sidelink data transmission, that is, both the resource pool 1 and the resource pool 2 meet the conditions, then UE1 and UE3 can select the resource pool 1 and/or the resource pool 2 to perform sidelink data transmission.

In an optional embodiment of the present application, the method further includes that: the first terminal sends the first capability information of the first terminal to the second terminal corresponding to sidelink data transmission, in order that other terminal (that is, the second terminal) learns the first capability information of the first terminal, so that the second terminal can select a resource pool before performing sidelink data transmission with the first terminal. That the first terminal sends the first capability information of the first terminal to the second terminal corresponding to the sidelink data transmission includes at least one of the following: that the first terminal sends the first capability information of the first terminal to the second terminal corresponding to the sidelink data transmission through a second sidelink RRC signaling; that the first terminal sends the first capability information of the first terminal to the second terminal corresponding to the sidelink data transmission through a PSSCH.

Using the above technical solutions of the embodiments of the present application, at least one resource pool for sidelink data transmission is configured for the terminal through the network device, where the at least one resource pool is located in the BWP of the first terminal, and different resource pools can correspond to different bandwidths, so that the terminal can select one or more resource pools from the configured at least one resource pool to perform sidelink data transmission according to its own capability and/or the capability of the receiving terminal, and thus when communicating with terminals with different capabilities, the terminal can use the corresponding resource pool to perform sidelink data transmission, which improves bandwidth utilization.

An embodiment of the present application also provides a network device. FIG. 5 is a schematic diagram of a structural composition of a network device according to an embodiment of the present application; as shown in FIG. 5, the network device includes a configuration unit 31 and a first communication unit 32; where,

the configuration unit 31 is configured to configure at least one resource pool for sidelink data transmission for a first terminal; where the at least one resource pool is located in a bandwidth part BWP of the first terminal;

the first communication unit 32 is configured to send configuration information for indicating a configuration of the at least one resource pool to the first terminal.

In an optional embodiment of the present application, the configuration information is used for indicating a configuration of a first resource pool in the at least one resource pool. The configuration of the first resource pool includes destination address information, and the destination address information is used for determining a second terminal which performs sidelink data transmission with the first terminal based on the first resource pool.

In an optional embodiment of the present application, the destination address information includes at least one of the following types of information: terminal identification, group identification, service type identification, and proximity service identification.

In an optional embodiment of the present application, the configuration of the first resource pool includes at least one of the following: at least one piece of destination address information belonging to a same category, and at least two pieces of destination address information belonging to different categories.

In an optional embodiment of the present application, the at least one resource pool includes at least one second resource pool, where the at least one second resource pool is used for performing sidelink data transmission with a terminal with the lowest bandwidth capability; or, the at least one second resource pool is used for the first terminal to perform sidelink broadcast transmission.

In an optional embodiment of the present application, a configuration of the at least one second resource pool indicated by the configuration information does not include destination address information.

In an optional embodiment of the present application, the first communication unit 32 is configured to send the configuration information indicating the configuration of the at least one resource pool to the first terminal through at least one of a first broadcast message, a first RRC signaling, and a downlink control channel.

In an optional embodiment of the present application, the first communication unit 32 is further configured to receive assistance information sent by the first terminal; where the assistance information includes at least one of the following information: first capability information of the first terminal, second capability information of a second terminal corresponding to sidelink data transmission performed by the first terminal, and identification information;

The identification information includes at least one of the following information: terminal identification information and group identification information.

In an optional embodiment of the present application, the first communication unit 32 is configured to receive the assistance information sent by the first terminal through at least one of a second RRC signaling, uplink control information, an SR, and a BSR.

In an optional embodiment of the present application, the first capability information and/or the second capability information are represented by capability level identification, where the capability level identification corresponds to the maximum bandwidth supported by the first terminal or the second terminal.

In an optional embodiment of the present application, the configuration unit 31 is configured to configure at least one resource pool for sidelink data transmission for the first terminal based on the assistance information.

In the embodiments of the present application, the configuration unit 31 in the network device may be implemented by a central processing unit (CPU), a digital signal processor (DSP), a microcontroller unit (MCU) or a field-programmable gate array (FPGA) in actual applications; the first communication unit 32 in the network device may be implemented through a communication module (including: a basic communication suite, an operating system, a communication module, a standardized interface and protocol, etc.) and a transceiving antenna in actual applications.

It should be noted that when the network device provided in the above embodiments performs the resource pool configuration, the division of the above program modules is used only as an example for illustration. In actual applications, the above processing may be allocated to be completed by different program modules as needed, that is, an internal structure of the network device is divided into different program modules to complete all or part of the processing described above. In addition, the network device provided in the above embodiments and the embodiments of the method for configuring a resource pool belong to the same concept, and the specific implementation process has been detailed in the method embodiments, which will not be repeated here.

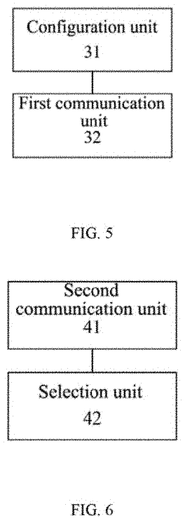

An embodiment of the present application also provides a terminal, and the terminal is a first terminal. FIG. 6 is a schematic diagram of a structural composition of a terminal according to an embodiment of the present application; as shown in FIG. 6, the terminal includes a second communication unit 41 and a selection unit 42. The second communication unit 41 is configured to obtain configuration information for indicating a configuration of at least one resource pool sent by a network device; where the at least one resource pool is located in a bandwidth part BWP of the first terminal;

the selection unit 42 is configured to perform sidelink data transmission according to the configuration information.

In an optional embodiment of the present application, the configuration information is used for indicating a configuration of a first resource pool in the at least one resource pool. The configuration of the first resource pool includes destination address information, and the destination address information is used for determining a second terminal which performs sidelink data transmission with the first terminal based on the first resource pool.

In an optional embodiment of the present application, the destination address information includes at least one of the following types of information: terminal identification, group identification, service type identification, and proximity service identification.

In an optional embodiment of the present application, the configuration of the first resource pool includes at least one of the following: at least one piece of destination address information belonging to a same category, and at least two pieces of destination address information belonging to different categories.

In an optional embodiment of the present application, the at least one resource pool includes at least one second resource pool, where the at least one second resource pool is used for performing sidelink data transmission with a terminal with the lowest bandwidth capability; or, the at least one second resource pool is used for the first terminal to perform sidelink broadcast transmission.

In an optional embodiment of the present application, a configuration of the at least one second resource pool indicated by the configuration information does not include destination address information.

In an optional embodiment of the present application, the second communication unit 41 is configured to receive the configuration information for indicating the configuration of the at least one resource pool sent by the network device through at least one of a first broadcast message, a first RRC signaling, and a downlink control channel.

In an optional embodiment of the present application, the second communication unit 41 is further configured to send assistance information to the network device; where the assistance information includes at least one of the following information: first capability information of the first terminal, second capability information of a second terminal corresponding to sidelink data transmission performed by the first terminal, and identification information; the identification information includes at least one of the following information: terminal identification information and group identification information.

In an optional embodiment of the present application, the second communication unit 41 is configured to send the assistance information to the network device through at least one of a second RRC signaling, uplink control information, an SR, and a BSR.

In an optional embodiment of the present application, the first capability information and/or the second capability information are represented by capability level identification, where the capability level identification corresponds to the maximum bandwidth supported by the first terminal or the second terminal.

In an optional embodiment of the present application, the selection unit 42 is configured to select one or more resource pools from the at least one resource pool to perform sidelink data transmission according to the configuration information.

In an optional embodiment of the present application, the selection unit 42 is configured to select one or more resource pools from the at least one resource pool to perform sidelink data transmission according to the first capability information of the first terminal and the second capability information of the second terminal corresponding to the sidelink data transmission.

In an optional embodiment of the present application, the second communication unit 41 is further configured to receive the second capability information of the second terminal corresponding to the sidelink data transmission.

In an optional embodiment of the present application, the second communication unit 41 is configured to receive the second capability information of the second terminal corresponding to the sidelink data transmission in at least one of the following manners: receiving the second capability information of the second terminal corresponding to the sidelink data transmission through a first sidelink RRC signaling; receiving a PSSCH sent by the second terminal corresponding to the sidelink data transmission, the second capability information of the second terminal being carried in the PSSCH.

In an optional embodiment of the present application, the second communication unit 41 is further configured to send the first capability information of the first terminal to the second terminal corresponding to the sidelink data transmission.

In an optional embodiment of the present application, the second communication unit 41 is configured to send the first capability information of the first terminal to the second terminal corresponding to the sidelink data transmission in at least one of the following manners: sending the first capability information of the first terminal to the second terminal corresponding to the sidelink data transmission through a second sidelink RRC signaling; sending the first capability information of the first terminal to the second terminal corresponding to the sidelink data transmission through a PSSCH.

In the embodiments of the present application, the selection unit 42 in the terminal may be implemented by a CPU, a DSP, an MCU, or an FPGA in the terminal in actual applications; the second communication unit 41 in the terminal may be implemented through a communication module (including: a basic communication suite, an operating system, a communication module, a standardized interface and protocol, etc.) and a transceiving antenna in actual applications.

It should be noted that when the terminal provided in the above embodiments undergoes the resource pool configuration, the division of the above program modules is used only as an example for illustration. In actual applications, the above processing may be allocated to be completed by different program modules as needed, that is, an internal structure of the terminal is divided into different program modules to complete all or part of the processing described above. In addition, the terminal provided in the above embodiments and the embodiments of the method for configuring a resource pool belong to the same concept, and the specific implementation process has been detailed in the method embodiments, which will not be repeated here.

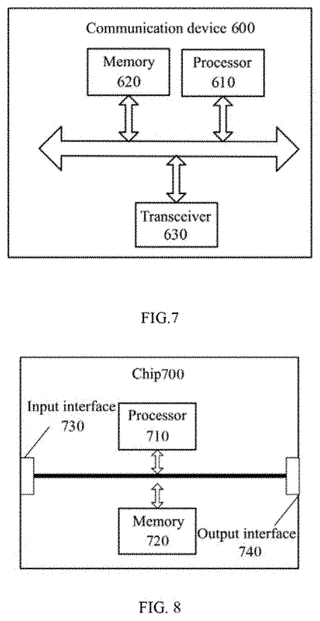

FIG. 7 is a schematic structural diagram of a communication device according to an embodiment of the present application. A communication device 600 may be a network device or a terminal. As shown in FIG. 7, the communication device 600 includes a processor 610, and the processor 610 can call and run a computer program from a memory to implement the method in the embodiments of the present application.

In an embodiment, as shown in FIG. 7, the communication device 600 may further include a memory 620. The processor 610 can call and run a computer program from the memory 620 to implement the method in the embodiments of the present application. The memory 620 may be a separate device independent of the processor 610, or may be integrated in the processor 610.

In an embodiment, as shown in FIG. 7, the communication device 600 may further include a transceiver 630. The processor 610 can control the transceiver 630 to communicate with other devices, and specifically, can send information or data to other devices, or receive information or data sent by other devices. The transceiver 630 may include a transmitter and a receiver. The transceiver 630 may further include an antenna, and the number of the antenna may be one or more.

In an embodiment, the communication device 600 may specifically be the network device of the embodiments of the present application, and the communication device 600 can implement corresponding procedures implemented by the network device in the methods of the embodiments of the present application, which will not be repeated here for brevity.

In an embodiment, the communication device 600 may specifically be the terminal of the embodiments of the present application, and the communication device 600 can implement corresponding procedures implemented by the terminal in the methods of the embodiments of the present application, which will not be repeated here for brevity.

FIG. 8 is a schematic structural diagram of a chip according to an embodiment of the present application. A chip 700 shown in FIG. 8 includes a processor 710, and the processor 710 can call and run a computer program from a memory to implement the methods in the embodiments of the present application.

In an embodiment, as shown in FIG. 8, the chip 700 may further include a memory 720. The processor 710 can call and run a computer program from the memory 720 to implement the methods in the embodiments of the present application. The memory 720 may be a separate device independent of the processor 710, or may be integrated in the processor 710.

In an embodiment, the chip 700 may further include an input interface 730. The processor 710 can control the input interface 730 to communicate with other devices or chips, and specifically, can obtain information or data sent by other devices or chips.

In an embodiment, the chip 700 may further include an output interface 740. The processor 710 can control the output interface 740 to communicate with other devices or chips, and specifically, can output information or data to other devices or chips.

In an embodiment, the chip can be applied to the network device in the embodiments of the present application, and the chip can implement corresponding procedures implemented by the network device in the methods of the embodiments of the present application, which will not be repeated here for brevity.

In an embodiment, the chip can be applied to the terminal in the embodiments of the present application, and the chip can implement corresponding procedures implemented by the terminal in the methods of the embodiments of the present application, which will not be repeated here for brevity.

It should be understood that the chip mentioned in the embodiments of the present application may also be referred to as a system-level chip, an SoC, a system-on-chip, or a system-on-a-chip, etc.

It should be understood that the processor of the embodiments of the present application may be an integrated circuit chip with signal processing capability. In the implementation process, each step of the above-mentioned method embodiments can be completed by hardware integrated logic circuits in the processor or instructions in the form of software. The above-mentioned processor may be a general-purpose processor, a digital signal processor (DSP), an application specific integrated circuit (ASIC), a field programmable gate array (FPGA) or other programmable logic devices, discrete gates or transistor logic devices, discrete hardware components, and can implement or execute the methods, steps, and logical block diagrams disclosed in the embodiments of the present application. The general-purpose processor may be a microprocessor or the processor may also be any conventional processor or the like. The steps of the methods disclosed in combination with the embodiments of the present application may be directly embodied as being executed and completed by a hardware decoding processor, or being executed and completed by a combination of hardware and software modules in the decoding processor. The software modules may be located in a random access memory, a flash memory, a read-only memory, a programmable read-only memory, or an electrically erasable programmable memory, a register or other mature storage medium in the field. The storage medium is located in the memory, and the processor reads information in the memory and completes the steps of the above methods in combination with its hardware.

It can be understood that the memory in the embodiments of the present application may be a volatile memory or a non-volatile memory, or may include both volatile and non-volatile memories. The non-volatile memory may be a read-only memory (ROM), a programmable read-only memory (Programmable ROM, PROM), an erasable programmable read-only memory (Erasable PROM, EPROM), and an electrically erasable programmable read-only memory (Electrically EPROM, EEPROM) or a flash memory. The volatile memory may be a random access memory (RAM), which is used as an external cache. By way of exemplary but not restrictive description, many forms of RAMs are available, such as a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM) and a direct Rambus random access memory (Direct Rambus RAM, DR RAM). It should be noted that the memories of the systems and methods described herein are intended to include, but are not limited to, these and any other suitable types of memories.

It should be understood that the foregoing memories are exemplary but not restrictive. For example, the memory in the embodiments of the present application may also be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synch link dynamic random access memory (synch link DRAM, SLDRAM) and a direct Rambus random access memory (Direct Rambus RA, DR RAM), etc. That is to say, the memories in the embodiments of the present application are intended to include, but are not limited to, these and any other suitable types of memories.

An embodiment of the present application also provides a communication system, which includes a terminal and a network device. The terminal can be configured to implement corresponding functions implemented by the terminal in the above methods, and the network device can be configured to implement corresponding functions implemented by the network device in the above methods, which will not be repeated here for brevity.

An embodiment of the present application also provides a computer-readable storage medium for storing a computer program which causes a computer to execute corresponding procedures of the method described in any one of the embodiments of the present application. Detailed description will not be repeated here for brevity.

An embodiment of the present application also provides a computer program product, including computer program instructions which cause a computer to execute corresponding procedures of the method described in any one of the embodiments of the present application. Detailed description will not be repeated here for brevity.

An embodiment of the present application also provides a computer program which causes a computer to execute corresponding procedures of the method described in any one of the embodiments of the present application. Detailed description will not be repeated here for brevity.

Those of ordinary skill in the art may be aware that the units and algorithm steps of the examples described in combination with the embodiments disclosed herein can be implemented by electronic hardware or a combination of computer software and electronic hardware. Whether these functions are executed by hardware or software depends on the specific application and design constraint conditions of the technical solution. Professionals and technicians can use a different method for each specific application to implement the described functions, but such implementation should not be considered as going beyond the scope of the present application.

Those skilled in the art can clearly understand that, for the convenience and conciseness of description, corresponding processes in the foregoing method embodiments can be referred to for the specific working processes of the above-described systems, apparatuses and units, and will not be repeated here.

It should be understood that the devices and methods disclosed in several embodiments according to the present application may be implemented in other ways. For example, the above-described apparatus embodiments are only exemplary. For example, the division of the units is only a logical function division, and there may be other divisions in actual implementations, for example, multiple units or components may be combined or may be integrated into another system, or some features may be ignored or not implemented. In addition, the displayed or discussed mutual coupling or direct coupling or communication connection may be indirect coupling or communication connection through some interfaces, apparatuses or units, and may be in electrical, mechanical or other forms.

The units described as separate components may or may not be physically separated, and the components displayed as units may or may not be physical units, that is, they may be located in one place, or they may be distributed on multiple network units. Some or all of the units may be selected according to actual needs to achieve the objectives of the solutions of the embodiments.

In addition, the functional units in the various embodiments of the present application may be integrated into one processing unit, or each unit may also physically exist alone, or two or more units may be integrated into one unit.

If the functions are implemented in the form of software functional units and sold or used as an independent product, they can be stored in a computer-readable storage medium. Based on this understanding, a technical solution of the present application essentially or the part that contributes to the existing technology or the part of the technical solution can be embodied in the form of a software product, and the computer software product is stored in a storage medium, including several instructions for causing a computer device (which may be a personal computer, a server, or a network device, etc.) to execute all or part of the steps of the methods described in the various embodiments of the present application. The foregoing storage medium includes: a U disk, a mobile hard disk, a read-only memory (ROM), a random access memory (RAM), a magnetic disk, an optical disk or other media that can store program codes.

The above are only specific implementations of the present application, and the protection scope of the present application is not limited thereto. Any person skilled in the art can easily think of changes or substitutions within the technical scope disclosed in the present application, which should be covered within the protection scope of the present application. Therefore, the protection scope of the present application shall be subject to the protection scope of the claims.

What is claimed is:

1. A method for configuring a resource pool, comprising:
configuring, by a network device, at least one resource pool for sidelink data transmission for a first terminal; wherein the at least one resource pool is located in a bandwidth part BWP of the first terminal;
sending, by the network device, configuration information for indicating a configuration of the at least one resource pool to the first terminal.

2. The method according to claim 1, wherein the configuration information is used for indicating a configuration of a first resource pool in the at least one resource pool, and the configuration of the first resource pool comprises destination address information, wherein the destination address information is used for determining a second terminal which performs sidelink data transmission with the first terminal based on the first resource pool.

3. The method according to claim 2, wherein the destination address information comprises at least one of the following types of information: terminal identification, group identification, service type identification, and proximity service identification.

4. The method according to claim 1, wherein the at least one resource pool comprises at least one second resource pool, wherein the at least one second resource pool is used for performing sidelink data transmission with a terminal with a lowest bandwidth capability; or, the at least one second resource pool is used for the first terminal to perform sidelink broadcast transmission.

5. The method according to claim 4, wherein a configuration of the at least one second resource pool indicated by the configuration information does not comprise destination address information.

6. The method according to claim 1, wherein the sending, by the network device, the configuration information for indicating the configuration of the at least one resource pool to the first terminal comprises:
sending, by the network device, the configuration information for indicating the configuration of the at least one resource pool to the first terminal through at least one of a first broadcast message, a first radio resource control (RRC) signaling, and a downlink control channel.

7. The method according to claim 1, wherein the method further comprises:
receiving, by the network device, assistance information sent by the first terminal; wherein the assistance information comprises at least one of the following information: first capability information of the first terminal, second capability information of a second terminal corresponding to sidelink data transmission performed by the first terminal, and identification information;
the identification information comprises at least one of the following information: identification information of the first terminal, identification information of the second terminal, group identification information corresponding to the first terminal, and group identification information corresponding to the second terminal.

8. The method according to claim 7, wherein the receiving, by the network device, the assistance information sent by the first terminal comprises:
receiving, by the network device, the assistance information sent by the first terminal through at least one of a second RRC signaling, uplink control information, a scheduling request (SR), and a buffer status report (BSR).

9. The method according to claim 7, wherein the first capability information and/or the second capability information is represented by capability class identification, and the capability class identification corresponds to a maximum bandwidth supported by the first terminal or the second terminal.

10. A method for configuring a resource pool, comprising:
obtaining, by a first terminal, configuration information for indicating a configuration of at least one resource pool sent by a network device; wherein the at least one resource pool is located in a bandwidth part (BWP) of the first terminal;
performing, by the first terminal, sidelink data transmission according to the configuration information.

11. The method according to claim 10, wherein the configuration information is used for indicating a configuration of a first resource pool in the at least one resource pool, and the configuration of the first resource pool comprises destination address information, wherein the destination address information is used for determining a second terminal which performs sidelink data transmission with the first terminal based on the first resource pool.

12. The method according to claim 11, wherein the destination address information comprises at least one of the following types of information: terminal identification, group identification, service type identification, and proximity service identification.

13. The method according to claim 11, wherein the at least one resource pool comprises at least one second resource pool, wherein the at least one second resource pool is used for performing sidelink data transmission with a terminal with a lowest bandwidth capability; or, the at least one second resource pool is used for the first terminal to perform sidelink broadcast transmission.

14. The method according to claim 13, wherein a configuration of the at least one second resource pool indicated by the configuration information does not comprise destination address information.

15. The method according to claim 11, wherein the obtaining, by the first terminal, the configuration information for indicating the configuration of the at least one resource pool sent by the network device comprises:
receiving, by the first terminal, the configuration information for indicating the configuration of the at least one resource pool sent by the network device through at least one of a first broadcast message, a first radio resource control (RRC) signaling, and a downlink control channel.

16. The method according to claim 11, wherein the method further comprises:
sending, by the first terminal, assistance information to the network device; wherein the assistance information comprises at least one of the following information: first capability information of the first terminal, second capability information of a second terminal corresponding to the sidelink data transmission performed by the first terminal, and identification information;
the identification information comprises at least one of the following information: identification information of the first terminal, identification information of the second terminal, group identification information corresponding to the first terminal, and group identification information corresponding to the second terminal.

17. The method according to claim 16, wherein the sending, by the first terminal, the assistance information to the network device comprises:
sending, by the first terminal, the assistance information to the network device through at least one of a second RRC signaling, uplink control information, an SR, and a BSR.

18. The method according to claim 16, wherein the first capability information and/or the second capability information are represented by capability level identification, and the capability level identification corresponds to a maximum bandwidth supported by the first terminal or the second terminal.

19. A network device, comprising:
at least one processor,
an output interface connected with the at least one processor; and
a memory connected with the at least one processor;
wherein the instructions, when executable by the at least one processor, cause the at least one processor to:
control the output interface to configure at least one resource pool for sideline data transmission for the first terminal; wherein the at least one resource pool is located in a bandwidth part (BWP) of the first terminal;
send configuration information for indicating a configuration of the at least one resource pool to the first terminal.

20. A computer-readable storage medium for storing a computer program, wherein the computer program causes a computer to execute the method according to claim 1; or,
wherein the computer program causes a processor of a first terminal to execute following steps:
obtaining configuration information for indicating a configuration of at least one resource pool sent by a network device; wherein the at least one resource pool is located in a bandwidth part (BWP) of the first terminal;
performing sidelink data transmission according to the configuration information.
